(19) United States
(12) Patent Application Publication
(10) Pub. No.: US 2010/0332297 A1
(43) Pub. Date: Dec. 30, 2010

(54) REWARDING INTERNET ADVERTISING SYSTEM AND METHOD

(76) Inventor: Hung-Ting CHEN, Taipei City (TW)

Correspondence Address: Muncy, Geissler, Olds & Lowe, PLLC, 4000 Legato Road, Suite 310, FAIRFAX, VA, 22033, US

(21) Appl. No.: 12/750,025

(22) Filed: Mar. 30, 2010

(30) Foreign Application Priority Data
Jun. 25, 2009 (TW) 098121372

(51) Int. Cl. G06Q 30/00

(52) U.S. Cl. 705/14.2; 705/14.39; 705/14.19

(57) ABSTRACT

A rewarding Internet advertising system and method utilizes questions and answers in a limited time to acknowledge if members conform to incentives due to viewing advertisements, and this method can achieve the result of propagating advertisements and upgrading profits of viewing advertisements, this system includes a member administrating module, an advertisement displaying interface module, an advertisement administrating module, and a rewarding administrating module.

### FIELD OF THE INVENTION

The present invention relates to a rewarding digital advertising system and method, which especially utilizes questions and answers in a limited time to acknowledge if members conform to incentives due to viewing advertisements, and this rewarding Internet advertising system and method can reliably achieve the result of propagating advertisements and upgrading profits of viewing advertisements.

### BACKGROUND OF THE INVENTION

Owing to the newspaper deregulation, the patency of cable TV, and the rise of internet network, the number of viewers in every kind of media is dramatically declined, which makes media publicity no longer an effective way for advertisers. Therefore, how to attract consumers' attention by utilizing limited budget becomes another new thought of marketing communication.

Attribute to the rise of internet network, the cost of consumer exposure is highly reduced, hereby leads to advertisers' sharing parts of their advertising budget with internet members, and this kind of internet advertisement marketing method is so-called rewarding internet advertisement marketing. Most of current rewarding internet advertisement marketing uses electronic mail to attract their consumers' attention; however, the rewarding internet advertisement marketing with electronic mail is void of interesting, and this incentive program provides incentives for members only by the mode of receiving mail clicking links, and obtaining reward operation, which can lead to consumers neither lack of impression nor careless about the content of advertising as a result of can not promote benefits of advertising effectively.

Therefore, it would be desirable to solve these problems for the modern industry from promoting benefit of advertising effectively in order to attract consumers' attention and give deep impression by the rewarding internet advertisement marketing.

### SUMMARY OF THE INVENTION

Most of current related rewarding advertisement marketing uses electronic mail to advice consumers' clicking and linking correlated advertising contents as the resort of incentives. But this rewarding internet advertisement marketing with electronic mail is void of interesting and provides incentives only to obtain rewards, which may make consumers no impression on or careless about the content of advertising, and can not promote benefits of advertising effectively.

Accordingly, the object of the present invention is to provide a rewarding Internet advertising system, which can promote benefits of advertising effectively by deepening consumers' impression to the content of advertisement using an interesting marketing method.

### BRIEF DESCRIPTION OF THE FIGURES

FIG. 1 is a schematic flow chart of system structure of the present invention.

FIG. 2 is a schematic flow chart of advertisement display interface module of the present invention for receiving and renewing advertisements.

FIG. 3 is a schematic flow chart of advertisement display interface module of the present invention for viewing advertisements.

FIG. 4 is a schematic flow chart of advertisement administration module of the present invention for advertisement placements.

### DETAILED DESCRIPTION OF THE INVENTION

To achieve the goal mentioned above, a rewarding Internet advertising system utilizing questions and answers in a limited time to acknowledge if members qualify for the incentives due to viewing advertisements in order to achieve the result of propagating advertisements and upgrading profits of viewing advertisements is disclosed, the system comprises:

a member administrating module for providing requesting and quitting services to members and renewing members' information;

an advertisement displaying interface module bidirectionally connecting to the member administrating module, which is mounted on digital device of the customer's side for receiving contents of renewed and published advertisements and transmitting the viewing records of advertisements;

an advertisement administrating module bidirectionally connecting to the advertisement display interface module for managing the publishing process of an advertising, which converts the format of media files, estimates benefits of advertising, and generates reports of viewing advertisements;

a rewarding administrating module bidirectionally connecting to the member administrating module, which manages members' incentives due to viewing advertisements and releases rewards.

These detailed features and practices of the present invention will be described as follows in conjunction with the accompanying drawings.

### Examples

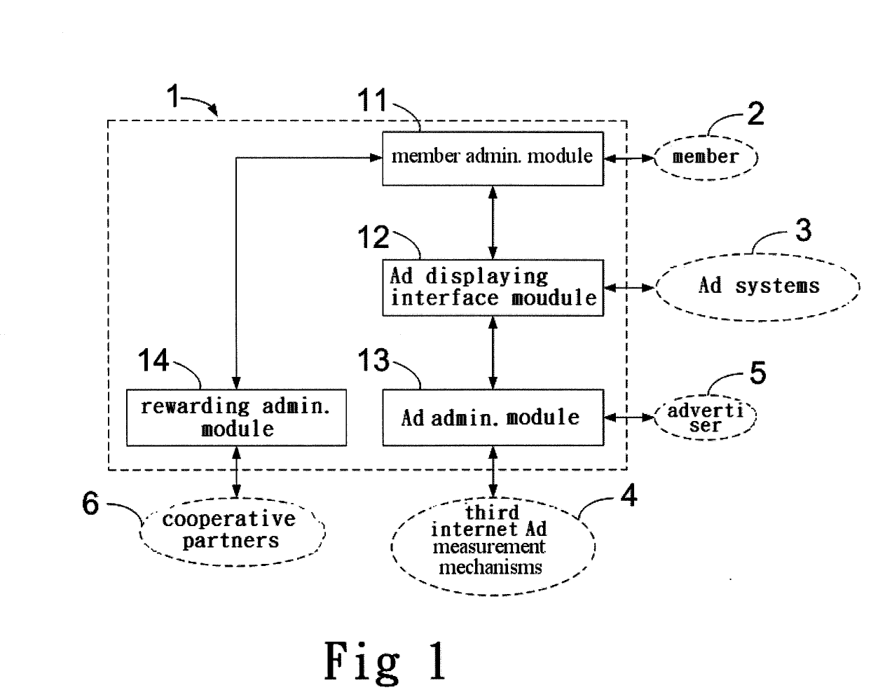

Please reference to FIG. 1, which is a schematic flow chart of system structure of the present invention. Disclosed rewarding Internet advertising system 1 of the present invention utilizes questions and answers in a limited time to acknowledge if members 2 conform to incentives due to viewing advertisements in order to achieve the result of propagating advertisements and upgrading profits of viewing advertisements, said system includes:

A member administrating module 11, for providing members 2 requesting and quitting services, and renewing related information of members 2;

An advertisement displaying interface module 12 bidirectionally connecting to the member administrating module 11, which is mounted on a digital device (such as, for example, a mobile phone, a personal computer, a notebook, a interactive television, or any other internet connected device) of customer's side for receiving content of renewed and published advertisements and transmitting viewing records of advertisements; while interconnects to a variety of third party interactive advertisement systems 3;

An advertisement administrating module 13 bidirectionally connecting to the advertisement displaying interface module 12 for managing the publishing process of advertising, which converts the format of media files, estimate benefits of advertising and generate reports of viewing advertisements; while interconnects to a variety of third party internet advertisement measuring mechanisms 4, wherein said file formats converted from media files comprise: digital video formats, digital audio formats, digital static or dynamic image formats, text file formats, or other related media file formats; while advertisers 5 can use said advertisement administrating module to manage their advertising contents and to obtain related reports;

A rewarding administrating module 14 bidirectionally connecting to the advertisement administrating module 13 for managing members' incentives due to viewing advertisements and releasing rewards, and releasing incentives on the basis of the integrated rewarding system 6 of various cooperative partners.

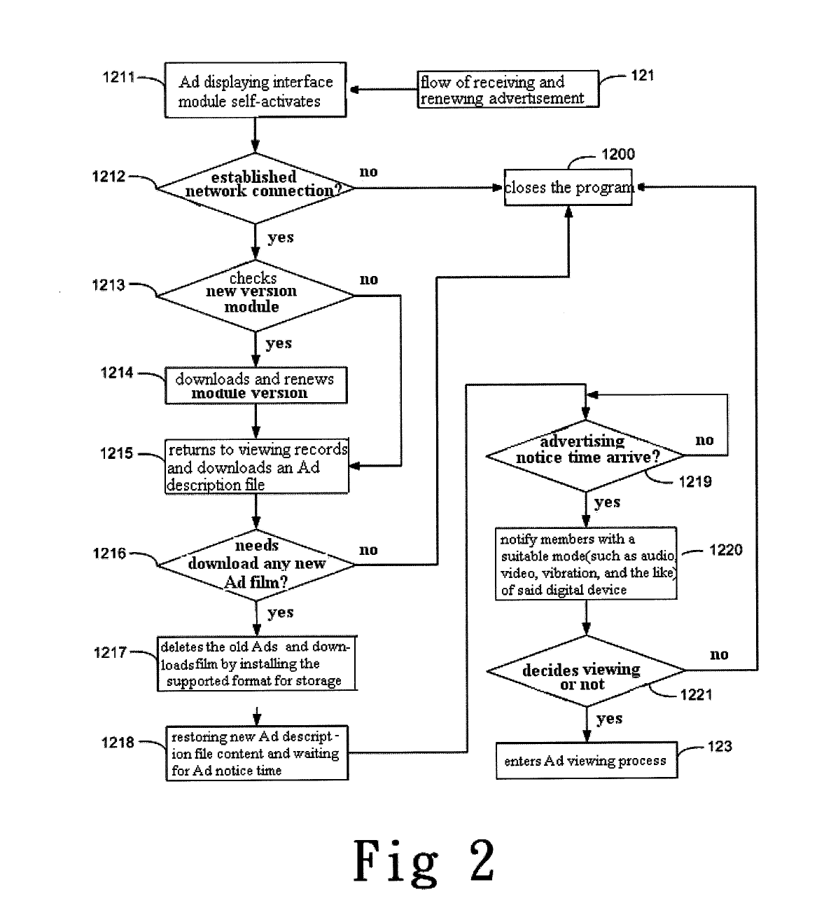

Please reference to FIG. 2, which is a schematic flow chart of advertisement displaying interface module for receiving and renewing advertisements. It goes into the receiving and renewing advertisement process 121 after starting up the member's digital device, and said advertisement displaying interface module will be self-activated 1211, then checks whether network connection is established 1212, if not, the program will be closed 1200 immediately. Checks if there is a new version of module or not when network connection is established 1213, if yes, then downloads and renews said new module version 1214, if not, then returns to viewing records and downloads an advertising description file 1215, and rechecks if there is any new advertising film needed to be downloaded 1211, if not, closes said program 1200. If there is a new advertising film to be loaded, after restoring new advertising description file content and waiting for advertising notice time 1218 the system will delete the old advertisement and download said advertising film by installing the supported format for storage 1217, then rechecks whether advertising notice time arrives or not 1219, if not, then repeats checking said advertising notice time until said advertising notice time arrives. Notify members with a suitable mode (such as audio, video, vibration, and the like) of said digital device 1220, thereafter members decide whether viewing or not 1221, the program will be closed if any member decides not to view said advertisement 1200, or enters the Ad viewing process if he or she decides to view said advertisement 123.

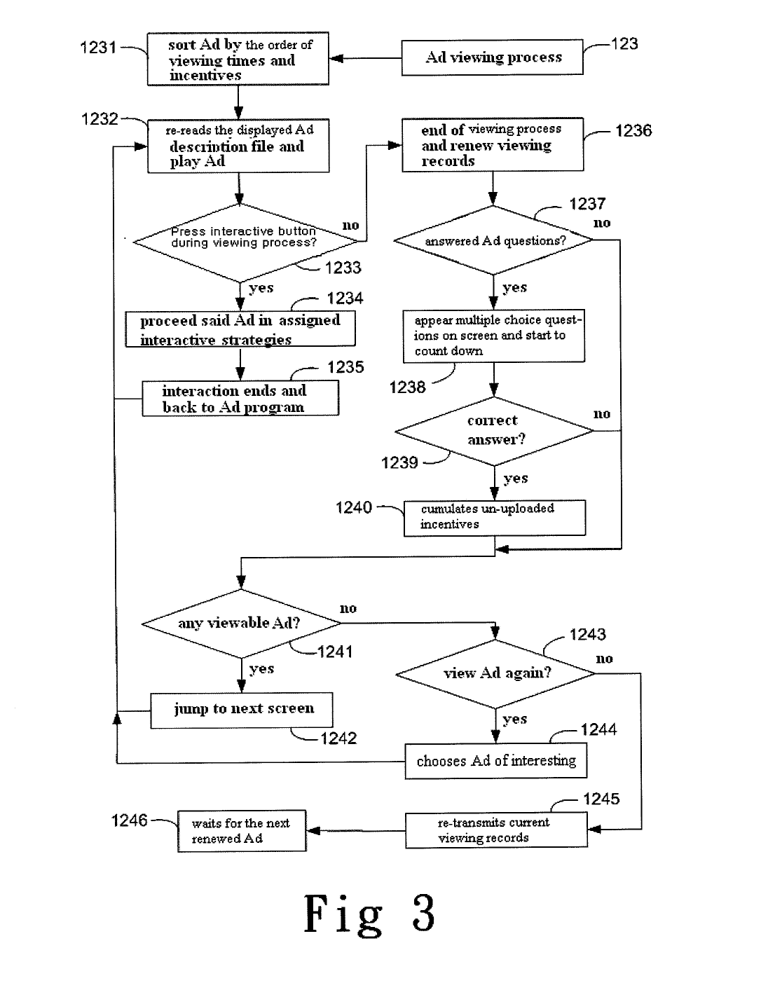

Please reference to FIG. 3, which is a schematic flow chart of advertisement displaying interface module for viewing advertisements. When said member views an advertisement, the advertisement displaying interface module will enter Ad viewing process 123 and sort said advertisement by the order of viewing times and incentives 1231, then re-reads the displayed advertising description file to play said advertisement 1232, it is followed by checking whether interactive button is pressed during the viewing process 1233, if yes, then said advertisement in an assigned-interactive strategies 1234 will be proceeded until interaction ends then goes back to advertising program 1235. If the interactive button is not pressed during the viewing process, viewing records will be renewed until the end of the viewing process 1236, then checks whether or not answering questions from advertising 1237, multiple choice questions will appear on screen and start to countdown when confirming an unanswered question from advertising 1238, or otherwise determines if the answered question is correct or not 1239, and cumulates un-uploaded incentives when all questions are answered correctly 1240. It will jump over a step of cumulating un-uploaded incentives process 1240 if said member has already answered this question or made an incorrect answer, and checks directly if there exists any viewable advertising 1241, jumps to the next screen if there exists other advertising 1242, then returns to read the displayed advertising description file and proceeds to the step of publishing advertisement 1232. If any other advertising is absent, estimates said member whether viewing said advertisement again 1243, if yes, chooses advertisement of interesting 1244, then returns to read the displayed advertising description file and proceeds to the step of publishing advertisement 1232. When said member decides not to view the advertisements, then re-transmits current viewing records 1245 and waits for the next automatically renewed advertisement 1246.

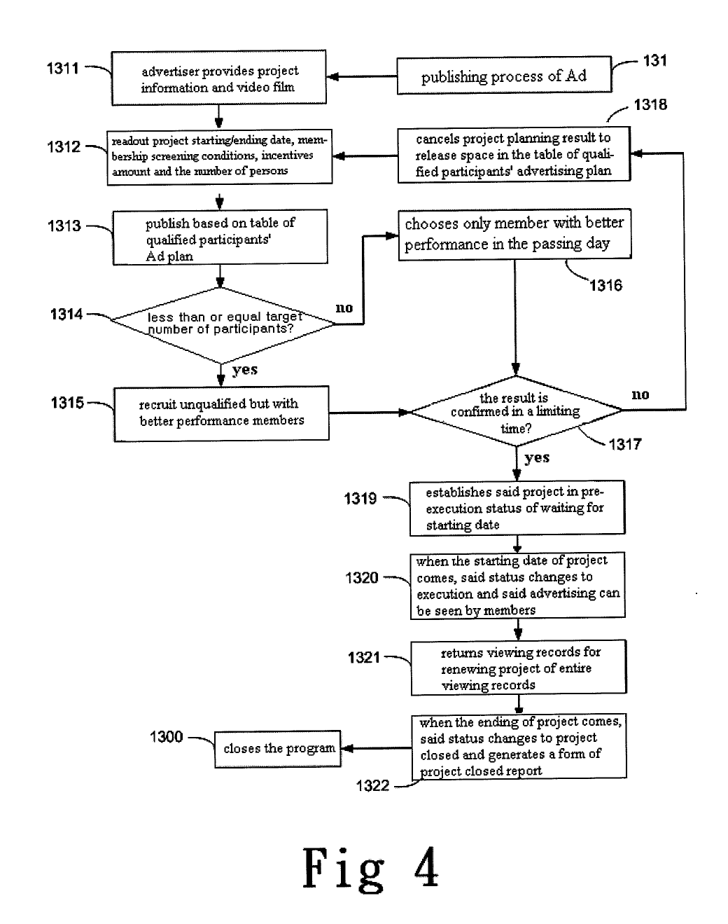

Please reference to FIG. 4, which is a schematic flow chart of advertisement administrating module for advertisement placements. When advertiser wants to upload new advertising, it will enter the publishing process of advertisement 131 for the convenience of advertiser to provide project information and video file of advertisement 1311, thereby readout project starting and ending date, membership screening conditions, incentives amount and the number of persons assigned by advertiser 1312, determines publishing or not based on table of qualified participants' advertisement plan 1313, and determines whether the number of qualified participants is less than or equal to target number of participants 1314, recruit members who are not qualified but with better performance 1315, then judges whether the result is confirmed in a limiting time 1317. If the number of qualified participants is larger than the target number of participants, then chooses only members with better performance in the passing day 1316 and judges whether the result is confirmed in a limiting time 1317. When the advertiser doesn't confirm the result in a limiting time, cancels project planning result to release space in the table of qualified participants' advertising plan 1318, thereafter returns to the step of reading out project starting and ending date, membership screening conditions, and the number of persons assigned by advertiser 1312. If advertiser confirms the result in a limiting time, then establishes said project in pre-execution status of waiting for starting date 1319, when the starting date of project comes, said status changes to execution and said advertising can be seen by members 1320, then returns viewing records for renewing project of entire viewing records 1321, when the ending of project comes, said status changes to project closed and generates a form of project closed report 1322, and finally closes the program 1300.

Although the invention has been described above in relation to its preferred embodiment, however, it is not used to limit the invention, but those skilled in the art will readily appreciate that many changes and modifications can be carried out without departing from the scope of the invention which is intended to be limiting only by the scope of the appended claims.

1. A rewarding Internet advertising system, comprising:
a member administrating module, for providing members' requesting and quitting services and renewing members' related information;
an advertisement displaying interface module bidirectionally connecting to the member administrating module, which is mounted on a digital device of the customer's side for receiving contents of renewed and published advertisements and transmitting viewing records of advertisements;
an advertisement administrating module bidirectionally connecting to the advertisement displaying interface module for managing publishing processes of advertising, which converts the format of media files, estimates benefits of advertising, and generates reports of viewing advertisements; and
a rewarding administrating module bidirectionally connecting to the member administrating module for managing members' incentives due to viewing advertisements and releasing rewards.

2. The rewarding Internet advertising system of claim 1, wherein said digital device may be a mobile phone, a personal computer, a notebook, an interactive television, or any other internet connected device.

3. The rewarding Internet advertising system of claim 1, wherein said file formats converted from media files may be a digital video format, a digital audio format, a digital static image format, a digital dynamic image format, or a text file format.

4. The rewarding Internet advertising system of claim 1, wherein said advertisement displaying interface module concurrently interconnects to third party interactive advertisement systems.

5. The rewarding Internet advertising system of claim 1, wherein said advertisement administrating module concurrently interconnects to third party measuring mechanisms of internet advertising.

6. The rewarding Internet advertising system of claim 1, wherein said rewarding administrating module concurrently interconnects to various integrated rewarding systems from cooperative partners.

7. A rewarding Internet advertising method, which utilizes questions and answers in a limited time to acknowledge if members conform to incentives due to viewing advertisements to achieve the result of propagating advertisements and upgrading profits of viewing advertisements.

8. The rewarding Internet advertising method of claim 7, wherein said interactive questions and answers in a limited time means that members should choose one out of multiple answer items for the questions appeared on screens and then started to countdown when at the end of advertisement.

9. The rewarding Internet advertising method of claim 8, wherein it is acknowledged that members conform to incentives due to viewing advertisements when said multiple choice question has a correct answer.

10. The rewarding Internet advertising method of claim 8, wherein it is acknowledged that members un-conform to incentives due to viewing advertisements when said multiple choice question has a wrong answer.

11. The rewarding Internet advertising method of claim 7, wherein the conformity of incentives is based on the integrated rewarding systems from cooperative partners.

12. The rewarding Internet advertising method of claim 9, wherein the conformity of incentives is based on the integrated rewarding systems from cooperative partners.

13. The rewarding Internet advertising method of claim 10, wherein the conformity of incentives is based on the integrated rewarding systems from cooperative partners.
